(19) United States
(12) Patent Application Publication
(10) Pub. No.: US 2012/0051594 A1
(43) Pub. Date: Mar. 1, 2012

(54) METHOD AND DEVICE FOR TRACKING MULTIPLE OBJECTS

(75) Inventors: Do Hyung Kim, Daejeon (KR); Jae Yeon Lee, Daejeon (KR); Woo Han Yun, Daejeon (KR)

(73) Assignee: ELECTRONICS AND TELECOMMUNICATIONS RESEARCH INSTITUTE, Daejeon (KR)

(21) Appl. No.: 13/215,797

(22) Filed: Aug. 23, 2011

(30) Foreign Application Priority Data
Aug. 24, 2010 (KR) 10-2010-0082072

(51) Int. Cl. G06K 9/00

(52) U.S. Cl. 382/103

(57) ABSTRACT

Disclosed are a method and a device for tracking multiple objects. In the object tracking method, when a plurality of objects are overlapped and thereafter, separated from each other again, color information of the objects, size information of the objects, and shape information of the objects are combined and used in order to maintain tracking consistency in which non-overlapped persons and separated persons coincide with each other. Therefore, while tracking the plurality of objects, each object can be stably tracked even under an environment in which moving objects are overlapped with each other.

### CROSS-REFERENCE TO RELATED APPLICATIONS

This application claims priority under 35 U.S.C. §119 to Korean Patent Application No. 10-2010-0082072, filed on Aug. 24, 2010, in the Korean Intellectual Property Office, the disclosure of which is incorporated herein by reference in its entirety.

### TECHNICAL FIELD

The present invention relates to a method and a device for tracking multiple objects, and more particularly, to a method and a device for tracking multiple objects that consistently track objects separated from non-overlapped objects when a plurality of objects moving arbitrarily are overlapped with each other.

### BACKGROUND

Technology (hereinafter, referred to as a ‘object tracking technology’) that tracks an object such as a moving person has been continuously researched and developed. The object tracking technology is used in various fields such as security, monitoring, an intelligent system such as a robot, and the like.

In a robot environment where the robot provides a predetermined service to a user, the robot should be able to recognize where the user is positioned by himself/herself. In this case, the object tracking technology is adopted while the robot recognizes where the user is positioned.

Meanwhile, one of problems which are the most difficult to solve in the object tracking technology is that tracking consistency should be maintained even when a plurality of moving persons are overlapped with each other and thereafter, separated from each other. That is, when a first tracker tracking person A and a second tracker tracking person B are provided, the first tracker and the second tracker should be able to continuously track A and B, respectively, even though A and B are overlapped with each other and thereafter, separated from each other again. If the tracking consistency cannot be ensured, previous history information acquired while tracking A and B cannot be reliable.

Up to now, various technologies that make non-overlapped persons and separated persons to coincide with each other have been researched and developed.

In the existing technologies that have been researched and developed up to now, a method of making the non-overlapped persons and the separated persons to coincide with each other by using feature information extracted from each person has been used. Representative feature information used to make the non-overlapped persons and the separated persons to coincide with each other generally include 1) information on movement directions and movement velocities of the persons, 2) information on shapes of the persons, and 3) colors of clothes.

However, the feature information which the existing technologies use all has fatal disadvantages. As a result, the existing technologies operate only under limited conditions.

The existing technologies have the following disadvantages.

1) The information on the movement directions and movement velocities of the persons basically assume an environment in which the persons move continuously. The corresponding information is not suitable as the feature information for coincidence when the persons are overlapped with each other for a long time or move in the same direction.

2) How accurately well the silhouette is separated is crucial to the shape information of the person as a method using silhouette featuring information of a person separated from a background. It is difficult to clearly separate the silhouette under an environment of not a simple background but a complicated background. Further, the corresponding information is not suitable even when the persons are overlapped with each other for a long time.

3) The information on the color of the clothes is widely used as feature information which has a high processing speed thereof and is not largely influenced even by the complicated background environment and a continuation time of the overlapped state. However, the corresponding information is not suitable when the colors of the clothes are similar to or the same as each other.

### SUMMARY

An exemplary embodiment of the present invention provides an object tracking method including: detecting a plurality of silhouette regions corresponding to a plurality of objects, in which a background image is removed from an input image including the plurality of objects; judging whether the plurality of silhouette regions are overlapped with or separated from each other; and consistently tracking a target object included in the plurality of objects even though the plurality of silhouette regions are overlapped with and thereafter, separated from each other by comparing feature information acquired by combining color information, size information, and shape information included in each of the plurality of silhouette regions which are not overlapped when the plurality of silhouette regions are overlapped with and thereafter, separated from each other and feature information acquired by combining the color information, the size information, and the shape information included in each of the plurality of silhouette regions which are overlapped with and thereafter, separated from each other, with each other.

Another exemplary embodiment of the present invention provides an object tracking device including: an object detecting unit detecting silhouette regions of a first object and a second object, in which a background image is removed from an input image including the first object and the second object; an overlapping/separation judging unit receiving the silhouette regions of the detected first and second objects per frame and judging per frame whether the silhouette regions of the first and second objects are separated from each other or the silhouette regions of the first and second objects are overlapped with each other depending on movement of the silhouettes of the first and second objects; and an object tracking unit consistently tracking the first and second objects even though the silhouette regions of the first and second objects are overlapped with and thereafter, separated from each other by comparing a first feature information acquired by combining color information, size information, and shape information included in each of the silhouette regions of the first and second objects which are not overlapped when the silhouette regions of the first and second objects are overlapped with and thereafter, separated from each other and a second feature information acquired by combining the color information, the size information, and the shape information included in each of the silhouette regions of the first and second objects which are overlapped with and thereafter, separated from each other, with each other according to a judgment result of the overlapping/separation judging unit.

Other features and aspects will be apparent from the following detailed description, the drawings, and the claims.

### BRIEF DESCRIPTION OF THE DRAWINGS

FIG. 1 is a schematic block diagram showing an internal configuration of a device for tracking an object according to an exemplary embodiment of the present invention.

FIG. 2 is a diagram showing an example of an input image outputted from an image inputting unit shown in FIG. 1.

FIG. 3 is a diagram showing an example of a silhouette image outputted from an object detecting unit shown in FIG. 1.

FIGS. 4 and 5 are diagrams for showing a state in which first and second objects are overlapped with each other and a state in which the first and second objects are separated from each other according to a judgment result of an overlapping/separation judgment unit shown in FIG. 1.

FIG. 6 is a diagram for describing information on colors of clothes in feature information extracted by an object tracking unit shown in FIG. 1.

FIG. 7 is a diagram for describing a method for detecting height information according to an exemplary embodiment of the present invention.

FIG. 8 is a diagram showing how information constituting collected feature information is used in order to make separated persons and non-overlapped persons to coincide with each other in a group zone according to an exemplary embodiment of the present invention.

FIG. 9 is a diagram showing an example of tracking a person under an environment in which overlapping occurs by using the object tracking device shown in FIG. 1.

FIG. 10 is a flowchart for describing a method for tracking an object according to an exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

According to the present invention, by combining feature information which can be acquired from arbitrarily moving objects, while the objects are overlapped with each other and thereafter, separated from each other, consistent tracking is ensured among non-overlapped objects and separated objects.

To this end, in the present invention, first, feature information of the separated objects is collected. Thereafter, an overlapped state of the objects and a separated state from the overlapped state are judged and in the case of the overlapped state, a group region including the overlapped objects is generated and the generated group region is tracked. The overlapped state of the objects is continuously tracked through the generated group region and the tracking of the group region. During the tracking of the group region, any feature information is not required to be collected and is just used as means for tracking.

When the tracking of the group region is terminated, that is, when the objects are separated from each other in the group region, the feature information of each of the separated objects is collected.

Thereafter, by comparing feature information of each of the objects collected before overlapping and feature information of each of the separated objects from the overlapped state with each other, tracking consistency is maintained. For more stable tracking consistency, feature information presented in the present invention is disclosed. The feature information will be described in detail with reference to the accompanying drawings.

As described above, in the present invention, tracking consistency can be secured through a tracking process of the group region defining the overlapped objects, a collecting process of the feature information of each of the non-overlapped objects and the feature information of each of the separated objects after the overlapping, and a comparing process of the collected feature information.

The present invention can be extensively applied to various fields such as security and monitoring fields, a smart environment, telematics, and the like and in particular, the present invention can be usefully applied as a base technology for providing an appropriate service to an objet such as a person which an intelligent robot intends to interact with. An object tracking device adopted in a robot system will be described as an example in a description referring to the accompanying drawings.

Hereinafter, exemplary embodiments of the present invention will be described in detail with reference to the accompanying drawings. Throughout the drawings, like reference numerals refer to like elements.

FIG. 1 is a schematic block diagram showing an internal configuration of a device for tracking an object according to an exemplary embodiment of the present invention.

Referring to FIG. 1, an object tracking device 100 according to an exemplary embodiment of the present invention is not particularly limited, but it is assumed that the object tracking device 100 is mounted on a robot (not shown) that interacts with a person and moves arbitrarily in a room. The object tracking device 100 mounted on the robot generally includes an image inputting unit 110, an object detecting unit 120, an overlapping/separation judging unit 130, an object tracking unit 160, and an information collecting unit 170, and further includes a group generating unit 140 and a group tracking unit 150.

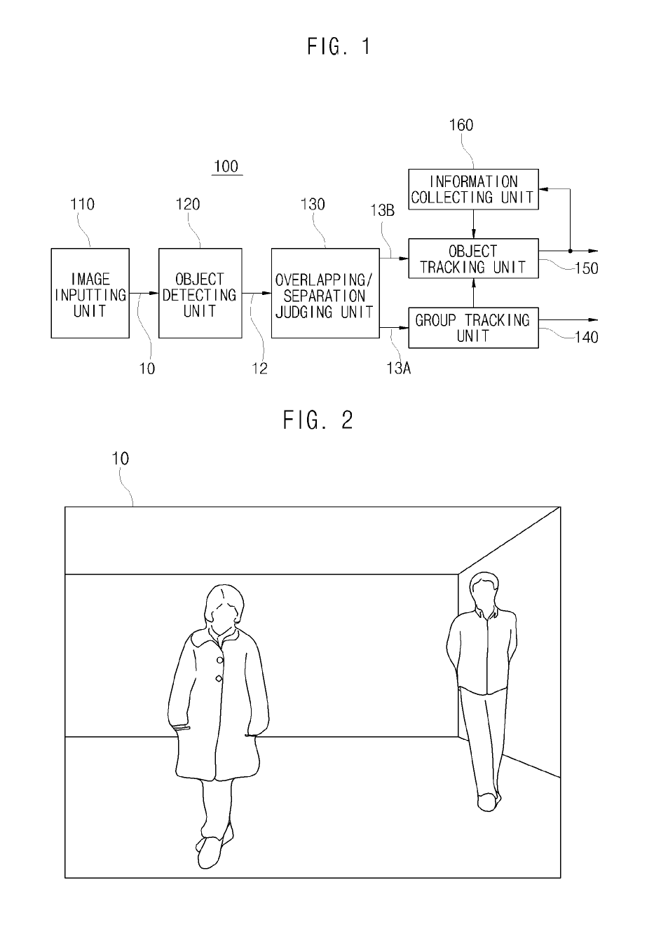

The image inputting unit 110 provides an input image 10 shown in FIG. 2, which is acquired from a camera provided in the robot (not shown) that moves in the room, to the object detecting unit 120. The input image may include a plurality of moving persons. The input image is converted into digital data by the image inputting unit 110 to be provided to the object detecting unit 120 as information type such as bitmap pattern. Hereinafter, as shown in FIG. 2, it is assumed that two moving persons are included in the input image and two moving persons are called a first object and a second object. That is, a person positioned at the left side of FIG. 2 is called the first object and a person positioned at the right side of FIG. 2 is called the second object.

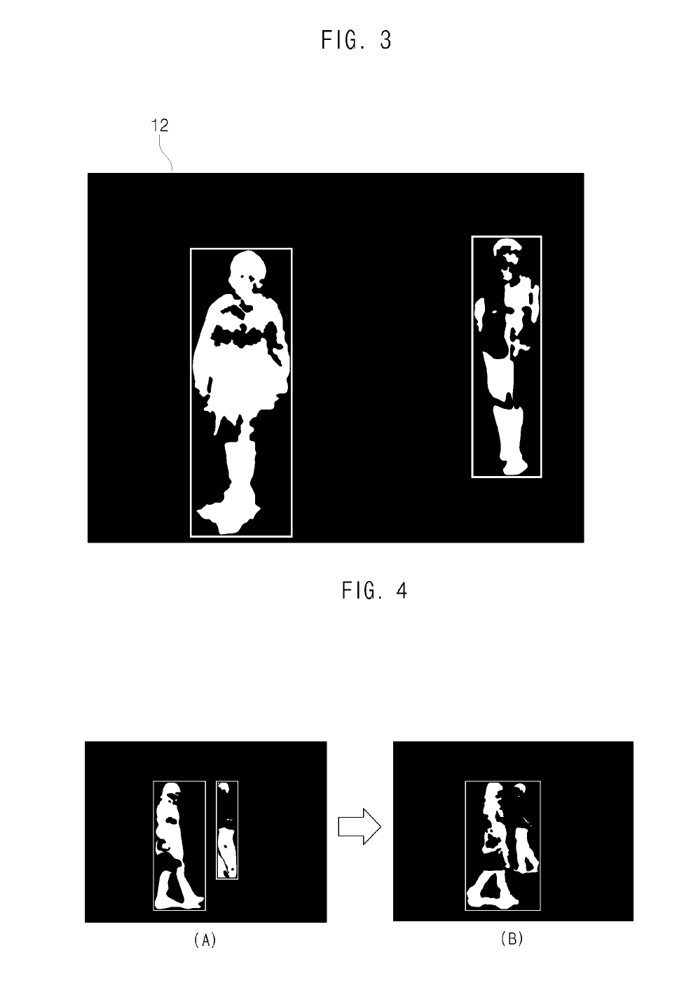

The object detecting unit 120 detects silhouette regions of the first and second objects from the input image 10 including the first and second objects, respectively, and outputs a detection result as a silhouette image 12 shown in FIG. 3. That is, the object detecting unit is a module that automatically generates and maintains a background image without a person by using a series of consecutive input images 10 and separates a silhouette of a person through a difference between the generated background image and the input image including the person.

Hereinafter, a process of detecting the silhouette regions of the first and second objects included in the silhouette image shown in FIG. 3 will be described in detail. Herein, since the process of detecting the silhouette region of the first object and the process of detecting the silhouette region of the second object are the same as each other, only the detection process of the silhouette region of the first object will be described.

The detection process of the silhouette region of the first object may be divided into a first process of detecting a first object region by detecting a motion region and an entire body region of the first object from an input image IM, a second process of generating a background image other than the first object region from the input image, and a third process of detecting the silhouette region of the first object based on a difference between the input image and the background image.

During the first process, in the process of detecting the motion region of the first object, a motion map is generated by displaying a region where a motion of the first object is generated by a pixel unit from one or more input images provided from the image inputting unit 110. Thereafter, a pixel-unit motion is detected as a block-unit region based on the generated motion map and the motion region is detected from the detected block-unit region. In addition, in the process of detecting the entire body region of the first object, the entire body region is detected from the input image 10 based on a face region and an omega shape region of the first object. Herein, the omega region represents a region showing a shape of an outline linking a head and a shoulder of the person. Finally, by mixing the detected motion region and the detected entire body region with each other, the first object region is detected from the input image 10.

During the second process, in the process of generating the background image, a region other than the first object region detected by the first process is modeled as the background image.

During the third process, an actual silhouette of the first object, i.e., the person is separated from the background image modeled by the second process and the silhouette region including the separated silhouette is detected. The detected silhouette region is displayed as a rectangular box as shown in FIG. 3.

Meanwhile, in the process of detecting the silhouette region of the second object, the silhouette region of the second object is detected in the same manner as the method of detecting the silhouette region of the first object through the first to third processes described above. The detected silhouette regions of the first and second objects are provided to the overlapping/separation judging unit 130 as the silhouette image 12.

Subsequently, the overlapping/separation judging unit 130 receives the silhouette image 12 including the detected silhouette region of the first object and the detected silhouette region of the second object (hereafter, referred to as a ‘rectangular region’) from the object detecting unit 120 by the unit of a frame. The overlapping/separation judging unit 130 is a module that judges whether the first and second objects are overlapped with each other or the overlapped first and second objects are separated from each other based on the rectangular region where the object exists in the silhouette image and if the first and second objects are overlapped with each other, the overlapping/separation judging unit 130 generates a group region including the overlapped first and second objects.

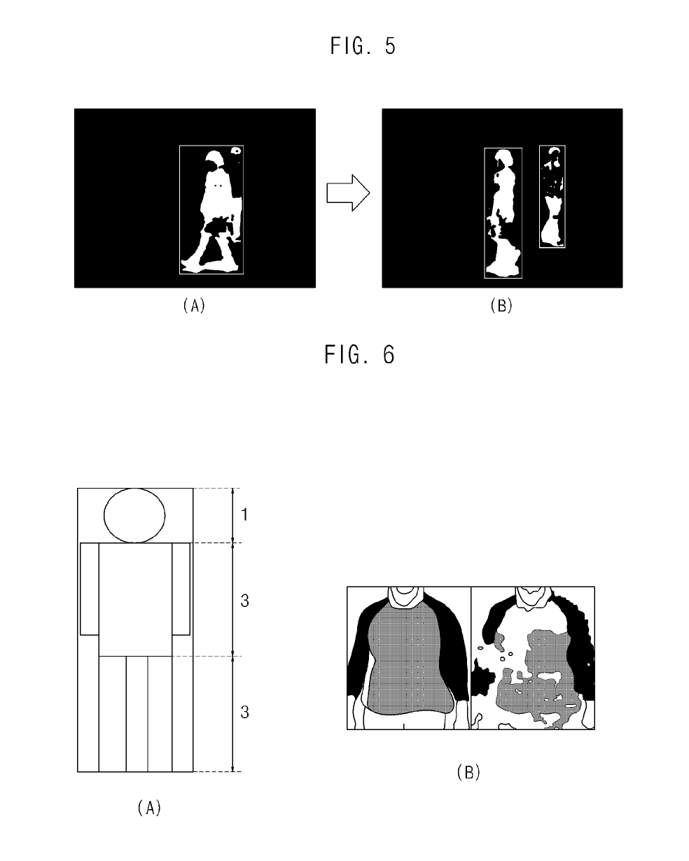

FIGS. 4 and 5 are diagrams for showing a process in which the overlapping/separation judging unit shown in FIG. 1 judges the case in which the objects are overlapped with each other and a case which the objects are again separated from each other from the overlapped state.

First, in FIG. 4A, when the first and second objects are separated from each other, that is, two rectangular regions (silhouette regions) are separated from each other. Thereafter, when the first and second objects move in a direction to face each other, the rectangular region (alternatively, the silhouette region) of the first object and the rectangular region (the silhouette region) of the second object are overlapped with each other as shown in FIG. 4B and the overlapping/separation judging unit 130 judges that “overlapping” occurs. When judging that the overlapping occurs, the overlapping/separation judging unit 130 merges two rectangular regions into one rectangular region and defines (generates) one merged rectangular region as the group region. For example, one rectangular box shown in FIG. 4B is defined as the group region.

In FIG. 5, one rectangular region is divided into two rectangular regions again. The group region shown in FIG. 4B is maintained for a predetermined time. That is, as shown in FIG. 5A, the group region is maintained until the silhouette region of the first object and the silhouette region of the second object are completely separated. Thereafter, when the first object and the second object are separated from each other in the group region, the silhouette region of the first objet and the silhouette region of the second object that are separated from each other are shown as shown in FIG. 5B.

The overlapping/separation judging unit 130 may judge an overlapped state and a separated state by using various methods (algorithms). For example, a distance value between a pixel coordinate corresponding to the center of the silhouette region of the first object and a center pixel coordinate corresponding to the center of the silhouette region of the second object is calculated per frame and by comparing the calculated distance value with a predetermined reference value, when the distance value is equal to or less than the reference value, the overlapping/separation judging unit 130 judges that the silhouette regions of the first and second objects are overlapped with each other. If the distance value is maintained to be equal to or less than the reference value and thereafter, is more than the reference value, it is judged that the silhouette regions of the first and second objects are overlapped with each other in a frame range in which the distance value is maintained to be equal to or less than the reference value and it is judged that the silhouette regions of the first and second objects are separated from each other in a frame range in which the distance value is more than the reference value.

When the overlapping/separation judging unit 130 judges that the first and second objects are overlapped with each other, the overlapping/separation judging unit 130 generates (defines) one group region including the silhouette regions of the first and second objects and provides a silhouette image 13A defining the group region to the group tracking unit 140. Meanwhile, even though the group region is generated, feature information of the silhouette of the first object and feature information of the silhouette of the second object are maintained as they are. The feature information will be described below in detail.

The group tracking unit 140 receives a series of silhouette images 13A defining the group region to track the group region. Herein, during tracking the group region, the group region is not tracked based on the feature information according to the exemplary embodiment of the present invention but the group region is tracked in consecutive frames based on only overlapping information included in consecutive silhouette images, i.e., information (e.g., simple coordinate values of pixels constituting the group region) associated with the group region.

Meanwhile, a silhouette image 13B not defining the group region by the overlapping/separation judging unit 130 is provided to the object tracking unit 150 as the consecutive frames.

The object tracking unit 150 collects per frame the feature information included in the silhouette regions of the first and second objects that are separated from each other and by comparing feature information collected in a present frame with feature information collected in a previous frame, the object tracking unit 150 tracks an object to be tracked at present between the first and second objects.

Specifically, the object tracking unit 150 extracts the feature information of the first and second objects by receiving a silhouette image of the previous frame and stores the extracted feature information in the information storing unit 160 implemented as a type such as a memory. Thereafter, when the object tracking unit 150 receives the silhouette image of the present frame, the object tracking unit 150 reads the feature information of the previous frame stored in the information storing unit 160 and compares the feature information of the previous frame and the feature information of the present frame with each other to perform tracking. Herein, the feature information is information in which color information, size information, and shape information included in each silhouette region are combined with each other and when the object is a person, the color information is clothes color information of the object, the size information is height information of the object, and the shape information is face information of the object.

When a target object to be tracked is included in the group region and thereafter, the target object is separated from the group region, the feature information collected by the object tracking unit 150 and the information collecting unit 160 may be used as information which is very useful to maintain tracking consistency for the target object.

As described above, the feature information used usefully to maintain tracking consistency will be described in detail.

FIG. 6 is a diagram for describing information on colors of clothes in feature information extracted by an object tracking unit shown in FIG. 1.

First, a process of extracting the clothes color information from the feature information will be described.

The object tracking unit 150 sets an upper body region for extracting the clothes color information before extracting the clothes color information from a silhouette region of a corresponding object.

The clothes color information is extracted from a rectangular region where a person exists, i.e., the upper body region of the person in the silhouette region. Specifically, in the clothes color information, a vertical height of the rectangular region is divided into three regions at a predetermined ratio and one of the three divided regions is set as the upper body region. In addition, the clothes color information is extracted in the set upper body region. For example, as shown in FIG. 6A, when it is assumed that the vertical height of the rectangular region is 7, a head region, the upper body region, and a lower body region are set at ratio 1:3:3 and the clothes color information is extracted from the upper body region corresponding to the set ratio. In this case, as shown in a left image of FIG. 4B, when only the upper body region is set in an original image including the background region, not the clothes color but a significant part of background region is included, and as a result, it is difficult to collect pure clothes color information accurately.

Therefore, in the exemplary embodiment of the preset invention, since the clothes color information is extracted from a silhouette image without the background region detected by the object detecting unit 120 shown in FIG. 1, interference by the background region can be minimized.

A detailed algorithm for extracting the clothes color information from the upper body region will be described below. In the exemplary embodiment of the present invention, a HSV color space capable of expressing the clothes color is used. That is, three moments are acquired for each of R, G, and B channels using Equation 1 and a total 9-dimensional feature vector is extracted with respect to one clothes color based on the three acquired moments. The extracted 9-dimensional feature vector is used as the clothes color information.

$$Ec = \frac{1}{N} {\sum }_{i = 1}^{N} i \cdot Hi \\ σ c = \sqrt{\frac{1}{N} {\sum }_{i = 1}^{N} {( i \cdot Hi - Ec )}^{2}} \\ Sc = \sqrt[3]{\frac{1}{N} {\sum }_{i = 1}^{N} {( i \cdot Hi - Ec )}^{3}} \qquad [ Equation 1 ]$$

Ec: Primary Moment

σc: Secondary Moment

Sc: Tertiary Moment

Hi: Color Histogram

N: Bin Of Color Histogram (256)

Next, a process of extracting the height information of the person among the feature information will be described below.

When the region where the person exists, i.e., the silhouette region is extracted from the input image, the object tracking unit 150 measures the height information of the person. When the camera and the person are positioned on the same plane and the entire body of the person exists in a view of the camera, the height information of the person can be measured using only one camera.

When the person is close to the camera, the shape of the person is upsized and when the person is distant from the camera, the shape of the person is naturally downsized, and as a result, it is difficult to measure a height by using only the shape of the person included in the image. In order to correct the point, information regarding a distance between the camera and the person is used to extract the height information. In general, the distance may be acquired by using a distance sensor such as a laser scanner or stereo matching using two or more cameras.

However, equipment such as the laser scanner is expensive and a technique such as the stereo matching is difficult to implement by using a low-priced system using one camera. Therefore, in the exemplary embodiment of the present invention, the height may be measured even by using one camera.

The silhouette of the object, that is, the person is extracted by the object detecting unit 120 and thereafter, the height information is measured in the silhouette image including the extracted silhouette. In this case, three assumptions described below are required.

The first assumption is that the robot mounted with the camera and the person are positioned on the same plane and the second assumption is that the person stands upright. In addition, the third assumption is that the entire body of the person is positioned in the camera view.

Next, when θ, an angel corresponding to a field of view of the camera is measured and known in advance, an angle value corresponding to a predetermined pixel, P can be acquired in proportional to Equation 2 described below.

$$α = arctan ( \frac{2 P tan ( θ )}{{H}_{I}} ) \qquad [ Equation 2 ]$$

That is, when a distance between the camera and an image surface is set as D, from Equations 1) and 2), Equation 3) can be acquired, and as a result, Equation 2 can be deduced.

$$\begin{matrix}tan ( θ ) = \frac{{H}_{I}}{2 D} & 1 ) \\ tan ( α ) = \frac{P}{D} & 2 ) \\ tan ( α ) = \frac{2 P tan ( θ )}{{H}_{I}} & 3 )\end{matrix}$$

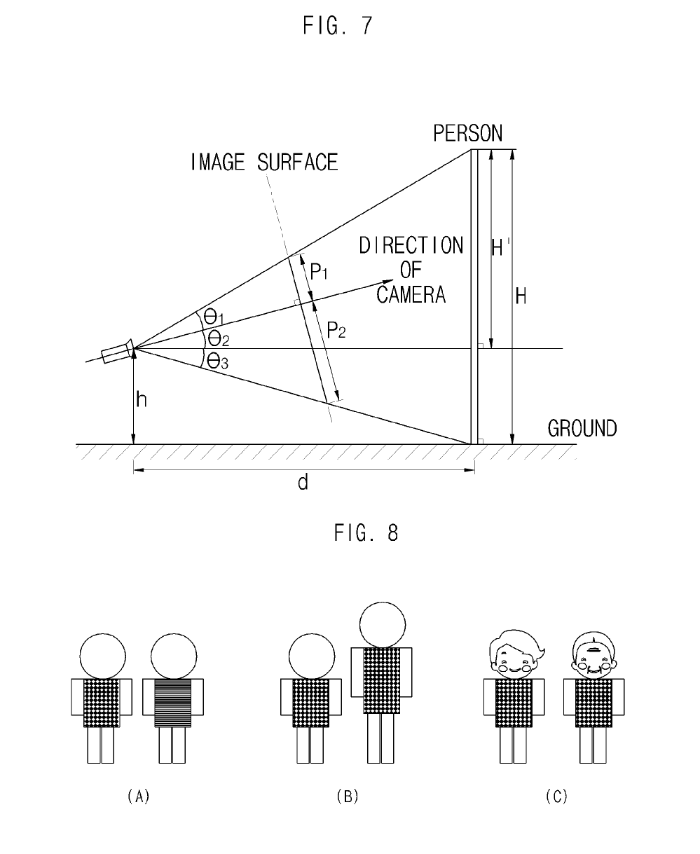

Meanwhile, referring to FIG. 7, since a mounting height of the camera in the robot can be known in advance, a height from a bottom plane to the camera, h, is an already known value and further, since a tilt angle of the camera, θ2 is a value controlled by the robot, the tilt angle is also an already known value.

Information which can be acquired by extracting the silhouette region with the input image based on the already known values includes P1 which is a pixel-unit distance to a vertical center from a head of silhouette included in the silhouette region and P2 which is a pixel-unit distance to a toe from the vertical center of the image.

Finally, θ1 and θ3 need to be acquired from P1 and P2 in order to acquire the height of the person, H and θ1 and (θ2+θ3) can be first acquired by using Equation 2 on the assumption of a pin hole camera model disregarding camera distortion. That is, since P of Equation 2 corresponds to P1 and P2 and alpha corresponds to θ1 and (θ2+θ3), each of θ1 and (θ2+θ3) is defined as shown in Equations 4) and 5).

$$\begin{matrix}θ 1 = arctan ( \frac{2 {P}_{1} tan ( θ )}{H} ) & 4 ) \\ ( θ 2 + θ 3 ) = arc tan ( \frac{2 {P}_{2} tan ( θ )}{H} ) & 5 )\end{matrix}$$

Among them, θ2 is a value controlled by the robot, and as a result, θ2 is an already known value. Consequently, θ1, θ2, and θ3 can all be acquired. When θ1, θ2, and θ3 are acquired, the distance d between the camera and the person can be acquired.

$$d = \frac{h}{tan ( {θ}_{3} )} \qquad [ Equation 3 ]$$

When the distance from the person to the camera is acquired through Equation 3, H′, a value acquired by subtracting the height of the camera height h from the person's height H can be acquired through Equation 4 below.

H′=d·tan(θ₁+θ₂) [Equation 4]

H, the person's height is finally acquired by Equation 5 combining Equations 3 and 4.

$$\begin{matrix}H = h + {H}^{′} \\ = h + \frac{h \cdot tan ( {θ}_{1} + {θ}_{2} )}{tan ( {θ}_{3} )}\end{matrix} \qquad [ Equation 5 ]$$

As such, information on the person's height can be acquired from the silhouette image acquired through one camera.

Next, in a process of extracting the face information in the feature information, when the person is separated from the group region, the face information is collected to maintain tracking consistency through recognition of a front face. The collected face information may be acquired by a face recognizer mounted with various face recognition algorithms. For example, a face recognizer mounted with the face recognition algorithm by an Adaboost technique may be used. In the exemplary embodiment of the present invention, even any face recognizer that can acquire the front face information may be used.

The information described up to now, i.e., the clothes color information, the height information, and the face information are continuously collected during the tracking and the collected information is stored in the information storing unit 160. In other words, when the upper body region is acquired, the clothes color information is collected, when the entire body of the person is displayed in the input image, the height information is acquired, and when the front face is displayed, the face information is acquired.

The information acquired with respect to the tracked person is usefully used to maintain tracking consistency when the persons are separated from the group.

FIG. 8 is a diagram showing how information constituting collected feature information is used in order to make separated persons and non-overlapped persons to coincide with each other in a group zone according to an exemplary embodiment of the present invention.

In FIG. 8, three cases are shown. First, in FIG. 8A, both faces of two persons displayed in the input image are not shown and heights of the two persons are similar to each other and in FIG. 8B, both the faces of the two persons are not displayed and clothes colors of the two persons are similar to each other. In addition, in FIG. 8C, the heights of the two persons are similar to each other and the clothes colors are similar to each other.

In FIG. 8A, when the faces are not displayed and the two persons having the heights similar to each other are overlapped with and thereafter, separated from each other, the clothes color information may be used as useful information. In FIG. 8B, when the faces are not displayed and the two persons having the clothes colors similar to each other are overlapped with and thereafter, separated from each other, the height information may be used as useful information. In FIG. 8C, when the heights and clothes colors of the two persons are similar to each other, the face information of the person may be used as useful information.

If two or more information can be used simultaneously, high reliability may be achieved in maintaining tracking consistency. For example, when the face of the person is not displayed, but the upper body and entire body of the person are displayed on a screen, clothes color information and height information of a predetermined person separated from the group region is compared with clothes color information and height information of the predetermined person which is not overlapped and the degree of coincidence between the information is integrally judged to thereby deduce a final result.

As described above, when three pieces of information on the person configuring the feature information presented in the exemplary embodiment of the present invention is used, tracking consistency for the person to be tracked can be maintained even though arbitrarily moving persons are overlapped with and thereafter, separated from each other.

FIG. 9 is a diagram showing an example of tracking a person under an environment in which overlapping occurs by using the object tracking device shown in FIG. 1.

Referring to FIG. 9, when two persons are separated from each other as shown in FIG. 9A, the object tracking device according to the exemplary embodiment of the present invention collects feature information including face information, height information, and clothes color information with respect to each of the two persons. Thereafter, when overlapping occurs as shown in FIG. 9B, the group region is generated. In this case, the feature information regarding the two persons that exist in the group region is maintained as it is. Thereafter, when two persons are separated from each other in the group region as shown in FIG. 9C, face information, height information, and clothes color information included in a region where each person exists, i.e., the silhouette region are acquired. Thereafter, the object tracking device according to the exemplary embodiment of the present invention compares information collected with respect to each person which is not included in the group with the acquired information and information having high similarity coincides with each other to thereby maintain tracking consistency.

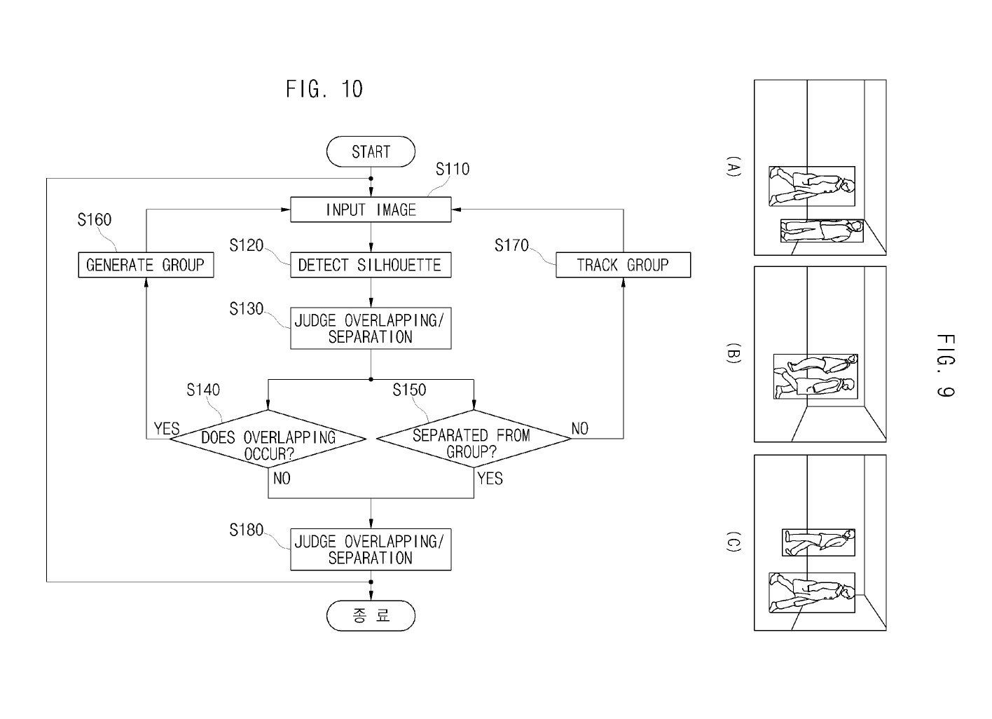

FIG. 10 is a flowchart for describing a method for tracking an object according to an exemplary embodiment of the present invention.

Referring to FIG. 10, first, an input image including a first object and a second object that move is inputted into an internal system through a camera provided in a robot (S110). The input image is inputted per frame and three or more objects may be included in the input image inputted per frame.

Subsequently, a background image without the first and second objects is detected from the input image including the first object and the second object and silhouette regions of the first and second objects are detected based on a difference between the input image and the background image (S120).

Subsequently, it is judged whether the silhouette regions of the first and second objects are overlapped with or separated from each other in a present frame depending on movement of the first and second objects (S130).

When the silhouette regions of the first and second objects are overlapped with each other in the present frame (S140), a group region including the silhouette regions of the first and second objects is generated (S160). Thereafter, an input image corresponding to the next frame is inputted and the processes (S120 and S130) are performed.

If the silhouette regions of the first and second objects are separated from each other in the present frame (S140) and the silhouette regions of the first and second objects are separated from each other even in the previous frame (S140), the feature information constituted by face information, height information, and clothes color information included in the silhouette regions of the first and second objects is collected and the feature information collected in the present frame is compared with the feature information collected in the previous frame to track a target object between the first and second objects (S180). In this case, although one information collected in the previous frame and one information collected in the present frame may be compared with each other, two or ore information collected in the previous frame and two or more information collected in the present frame are preferably compared with each other. That is, in order to ensure tracking consistency, two or more information may be used simultaneously.

Meanwhile, when the group region is generated in the present frame and the first and second objects included in the group region are separated from each other in the next frame, the process (S180) is performed. Similarly, two or more information may be used. That is, when the face of the person is not displayed, but the upper body and entire body of the person are displayed on the silhouette image (an image in which the background region is removed from the input image and only the region where the person exists is displayed), clothes color information and height information of a predetermined person separated from the group region are compared with clothes color information and height information of the predetermined person which is not overlapped and the degree of coincidence between the information is integrally judged to thereby deduce a final result. That is, an object to be tracked is tracked by combining the face information, the height information, and the clothes color information constituting the feature information. In other words, like the related art, two or more information are combined among the face information, the height information, and the clothes color information which are not changed depending on time, not information which is changed depending on time, such as a movement velocity and the combined feature information having high reliability is used to thereby ensure tracking consistency.

If the group region is generated in the present frame and the group region is maintained even in the next frame, that is, if the first and second objects are overlapped with each other even in the next frame, the group region is tracked (S170).

When the object tracking method according to the exemplary embodiment of the present invention is applied to the robot that interacts with the person, the robot tracks the target object to be tracked by associating the object tracking process and the group tracking process with each other.

According to the exemplary embodiments of the present invention, when a plurality of objects are overlapped and thereafter, separated from each other again, color information of the objects, size information of the objects, and shape information of the objects are combined and used in order to maintain tracking consistency in which non-overlapped persons and separated persons coincide with each other. Therefore, while tracking the plurality of objects, each object can be stably tracked even under an environment in which moving objects are overlapped with each other.

The exemplary embodiments of the present invention can be used as base technology for an intelligent robot to provide an appropriate service to an object such as a person which the robot intends to interact with and can be extensively applied to various fields such as security and monitoring fields, a smart environment, telematics, and the like in addition to the intelligent robot.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An object tracking method, comprising:
detecting a plurality of silhouette regions corresponding to a plurality of objects, in which a background image is removed from an input image including the plurality of objects;
judging whether the plurality of silhouette regions are overlapped with or separated from each other; and
consistently tracking a target object included in the plurality of objects even though the plurality of silhouette regions are overlapped with and thereafter, separated from each other by comparing feature information acquired by combining color information, size information, and shape information included in each of the plurality of silhouette regions which are not overlapped when the plurality of silhouette regions are overlapped with and thereafter, separated from each other and feature information acquired by combining the color information, the size information, and the shape information included in each of the plurality of silhouette regions which are overlapped with and thereafter, separated from each other, with each other.

2. The method of claim 1, wherein:
the plurality of objects are a plurality of persons, and
the color information is clothes color information of the person, the size information is height information of the person, and the shape information is face information of the person.

3. The method of claim 2, wherein:
when while the plurality of persons include a first person and a second person, a silhouette region of the first person and a silhouette region of the second person are separated from each other in a previous frame, and the silhouette region of the first person and the silhouette region of the second person are separated from each other even in a present frame, the first person is tracked as the target object,
in the consistently tracking of the target object,
the feature information included in the silhouette region of the first person in the previous frame and the feature information included in the silhouette region of the first person in the present frame are compared with each other to track the first person according to the comparison result.

4. The method of claim 2, wherein:
when while the plurality of persons include the first person and the second person, the silhouette region of the first person and the silhouette region of the second person are separated from each other in the previous frame, the silhouette region of the first person and the silhouette region of the second person are overlapped with each other in the present frame, and the silhouette region of the first person and the silhouette region of the second person which are overlapped with each other are separated from each other in a next frame, the first person is tracked as the target object,
in the consistently tracking of the target object,
the feature information included in the silhouette region of the first person in the previous frame and the feature information included in the silhouette region of the first person in the next frame are compared with each other to track the first person according to the comparison result.

5. The method of claim 4, wherein:
the judging of whether the plurality of silhouette regions are overlapped with each other or separated from each other includes generating a group region in which the silhouette region of the first person and the silhouette region of the second person are merged with each other, in the present frame, and further includes tracking the group region by comparing pixel information configuring the group region in a first frame among the plurality of frames and pixel information configuring the group region in a second frame which is temporally consecutive to the first frame with each other when the present frame is constituted by a plurality of frames.

6. The method of claim 5, wherein in the consistently tracking of the target object,
the first person is consistently tracked based on a tracking result of the group region and a comparison result of the feature information included in the silhouette region of the first person in the previous frame and the feature information included in the silhouette region of the first person in the next frame.

7. The method of claim 4, wherein in the consistently tracking of the target object,
the feature information included in the silhouette region of the first person in the previous frame and the feature information included in the silhouette region of the first person in the next frame are compared with each other, however,
two information of the clothes color information, the height information, and the face information constituting the feature information in the previous frame and two or more information of the clothes color information, the height information, and the face information constituting the feature information in the next frame are compared with each other to consistently track the first person even though the silhouette region of the first person and the silhouette region of the second person are overlapped with each other in the present frame.

8. The method of claim 1, wherein the detecting of the plurality of silhouette regions corresponding to the plurality of objects, in which the background image is removed from the input image including the plurality of objects, includes:
outputting an object region by detecting a motion region of the object and an entire body region of the object from the input image;
generating and outputting the background image other than the object region from the image; and
detecting the plurality of silhouette regions based on a difference between the image and the background image.

9. An object tracking device, comprising:
an object detecting unit detecting silhouette regions of a first object and a second object, in which a background image is removed from an input image including the first object and the second object;
an overlapping/separation judging unit receiving the silhouette regions of the detected first and second objects per frame and judging per frame whether the silhouette regions of the first and second objects are separated from each other and the silhouette regions of the first and second objects are overlapped with each other depending on the silhouettes of the first and second objects; and
an object tracking unit consistently tracking the first and second objects even though the silhouette regions of the first and second objects are overlapped with and thereafter, separated from each other by comparing a first feature information acquired by combining color information, size information, and shape information included in each of the silhouette regions of the first and second objects which are not overlapped when the silhouette regions of the first and second objects are overlapped with and thereafter, separated from each other and a second feature information acquired by combining the color information, the size information, and the shape information included in each of the silhouette regions of the first and second objects which are overlapped with and thereafter, separated from each other, with each other according to a judgment result of the overlapping/separation judging unit.

10. The device of claim 9, wherein:
the object is s person, and
the color information is clothes color information of the person, the size information is height information of the person, and the shape information is face information of the person.

11. The device of claim 10, further comprising:
an information collecting unit collecting the first and second feature information per frame, and
wherein the information collecting unit collects each of the first and second feature information arranged in each of a color item, a size item, and a shape item.

12. The device of claim 11, wherein the information collecting unit is provided in the object tracking unit.

13. The device of claim 9, wherein:
the overlapping/separation judging unit generates a group region including silhouettes of the first and second objects that are overlapped with each other when the silhouettes of the first and second objects are overlapped with each other according to the judgment result of the overlapping/separation judging unit, and
the object tracking device further includes a group tracking unit tracking the group region by using a difference between a previous image and a present image including the generated group region and providing the tracking result to the object tracking unit.

14. The device of claim 9, wherein the object detecting unit detects a background image without the first and second objects from the input image including the first and second objects and detects each of the silhouette regions of the first and second objects based on a difference between the input image and the background image.
